(19) United States
(12) Patent Application Publication
(10) Pub. No.: US 2023/0406435 A1
(43) Pub. Date: Dec. 21, 2023

(54) FRONT COWL STRUCTURE FOR SADDLE-TYPE VEHICLE

(71) Applicant: HONDA MOTOR CO., LTD., Tokyo (JP)

(72) Inventors: Kanya Takigawa, Wako-shi (JP); Sunao Miyauchi, Wako-shi (JP)

(21) Appl. No.: 18/207,704

(22) Filed: Jun. 9, 2023

(30) Foreign Application Priority Data
Jun. 15, 2022 (JP) 2022-096316
Jun. 15, 2022 (JP) 2022-096328

(51) Int. Cl. B62J 17/10; B62J 17/04

(52) U.S. Cl. CPC B62J 17/10; B62J 17/04

(57) ABSTRACT

A front cowl structure of a saddle-type vehicle includes a first front cowl portion and a second front cowl portion connected with each other via a concave portion. The concave portion expands in the left-right direction and inclines upward as the concave portion extends rearward. Left and right end portions of the first front cowl portion each have an inverted wing shape in a side view of the saddle-type vehicle.

### CROSS-REFERENCE TO RELATED APPLICATIONS

This application is based upon and claims the benefit of priority from Japanese Patent Applications No. 2022-096316 filed on Jun. 15, 2022 and No. 2022-096328 filed on Jun. 15, 2022, the contents of which are incorporated herein by reference.

### BACKGROUND OF THE INVENTION

### Field of the Invention

The present invention relates to a front cowl structure of a saddle-type vehicle.

### Description of the Related Art

JP 2022-047384 A discloses a saddle-type vehicle that has a front cowl and wing portions. The front cowl covers a front portion of the vehicle body from the front side. The wing portions are provided at both ends of the front cowl in the widthwise direction of the vehicle.

### SUMMARY OF THE INVENTION

The smaller the size (projected area) of the saddle-type vehicle when viewed from the front side, the smaller the aerodynamic drag (air drag) of the saddle-type vehicle. However, if the projected area reduces, the down force acting on the saddle-type vehicle reduces.

Therefore, as disclosed in JP 2022-047384 A, when inverted wings are provided at both ends of the front cowl, the down force becomes large. However, the aerodynamic drag also becomes large.

An object of the present invention is to solve the above-described problems.

A first aspect of the present invention is a front cowl structure for a saddle-type vehicle. The front cowl structure includes a first front cowl portion that covers a vehicle body from a front side, a second front cowl portion that covers the vehicle body from the front side below the first front cowl portion, and a concave portion that extends in a front-rear direction of the saddle-type vehicle, connects the first front cowl portion and the second front cowl portion, and is sunken inward in the vehicle widthwise direction, the concave portion expands outward in the vehicle widthwise direction and inclines upward as the concave portion extends rearward, and both end portions of the first front cowl portion have an inverted wing shape in a side view of the saddle-type vehicle.

In the present invention, the downforce can be increased by the first front cowl portion having an inverted wing shape. In addition, because wings are unnecessary, aerodynamic drag can be reduced. Thus, the motion performance (maximum speed and acceleration performance) of the saddle-type vehicle improves and as a result, the fuel consumption performance can improve. Further, the running air flowing along the concave portion flows upward and outward as the running air goes rearward. Thus, it is possible to mitigate the direct impact of the running air on the occupant of the saddle-type vehicle and further reduce the aerodynamic drag. Further, if the present invention is applied to a saddle-type vehicle of a supersport type, it becomes possible to realize a sharp design with a reduced vehicle width. Thus, the design of the saddle-type vehicle can be improved.

A second aspect of the present invention is a front cowl structure of a saddle-type vehicle. The front cowl structure includes a first front cowl portion that covers the vehicle body from a front side, and a second front cowl portion that covers the vehicle body from the front side below the first front cowl portion, wherein a front portion of the second front cowl portion is formed with an introduction port, a rear upper portion of the second front cowl portion is formed with a discharge port, the second front cowl portion is formed with a running air path that connects the introduction port and the discharge port with each other and the running air introduced from the introduction port is discharged rearward from the discharge port through the running air path, the running air path expands outward in the vehicle widthwise direction of the saddle-type vehicle and extends upward as the running air path approaches the discharge port, and a portion of the second front cowl portion above the running air path has an inverted wing shape in a side view of the saddle-type vehicle.

The present invention increases the down force by forming the portion of the second front cowl portion above the running air path into an inverted wing shape. In addition, because wings are unnecessary, aerodynamic drag can be reduced. Thus, the motion performance (maximum speed and acceleration performance) of the saddle-type vehicle can be improved, and as a result, the fuel consumption performance can be improved. Further, the running air flows from the introduction port through the running air path and is discharged backward from the discharge port. Accordingly, it is possible to prevent the stagnation of the running air near a front tire housing space. Further, the running air discharged backward from the discharge port flows along the occupant of the saddle-type vehicle. Thus, the discharged running air functions as an air curtain (wind protection) wraps the occupant. As a result, the wind protection range for the occupant can be reduced, and the size (projected area) of the saddle-type vehicle when viewed from the front can be reduced. Therefore, aerodynamic drag can be further reduced. Further, if the present invention is applied to a saddle-type vehicle of a supersport type, it becomes possible to realize a sharp design with a reduced vehicle width. Thus, the design of the saddle-type vehicle can be improved.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a right side view of a motorcycle according to a first embodiment.

FIG. 2 is a perspective view of the motorcycle shown in FIG. 1.

FIG. 3 is a front view of the motorcycle shown in FIG. 1.

FIG. 4 is a plan view of a front portion of the motorcycle shown in FIG. 1.

FIG. 5 is a sectional view taken along the line V-V in FIG. 4.

FIG. 6 is a right side view of a motorcycle according to a second embodiment.

FIG. 7 is a perspective view of the motorcycle shown in FIG. 6.

FIG. 8 is a front view of the motorcycle shown in FIG. 6.

FIG. 9 is a plan view of a front portion of the motorcycle shown in FIG. 6.

FIG. 10 is a sectional view taken along the line X-X in FIG. 9.

### DETAILED DESCRIPTION OF THE INVENTION

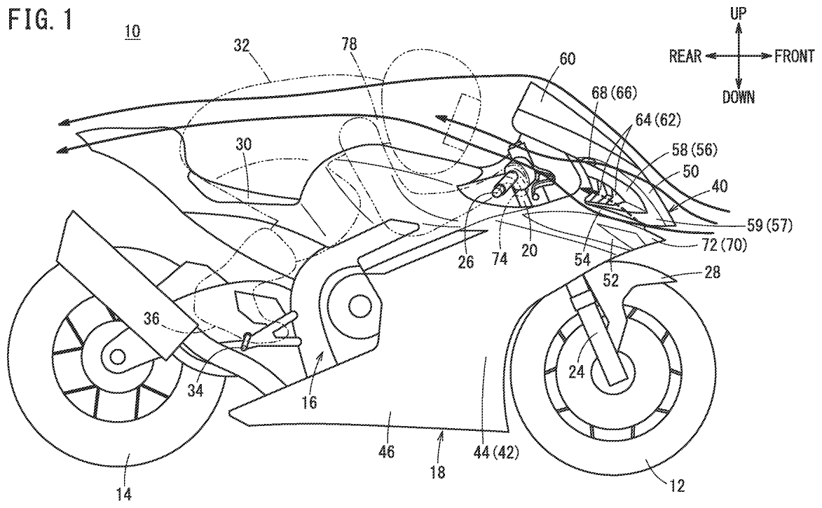

A motorcycle 10 (saddle-type vehicle) according to a first embodiment will be described with reference to FIGS. 1 to 5.

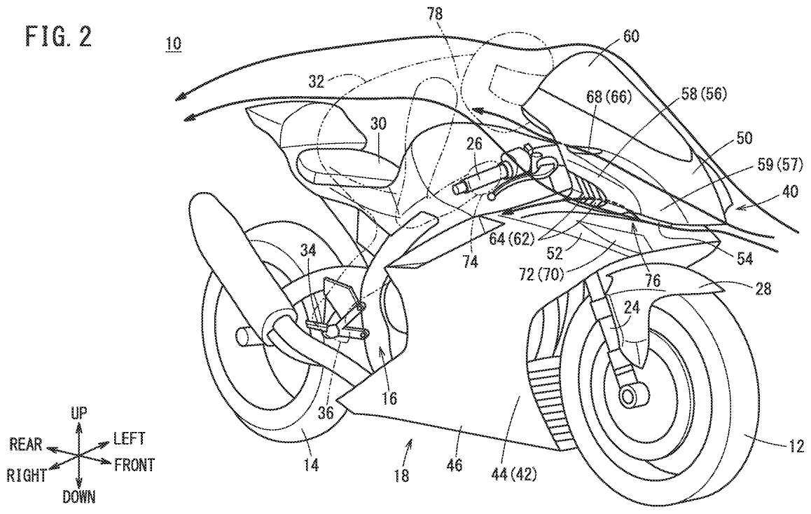

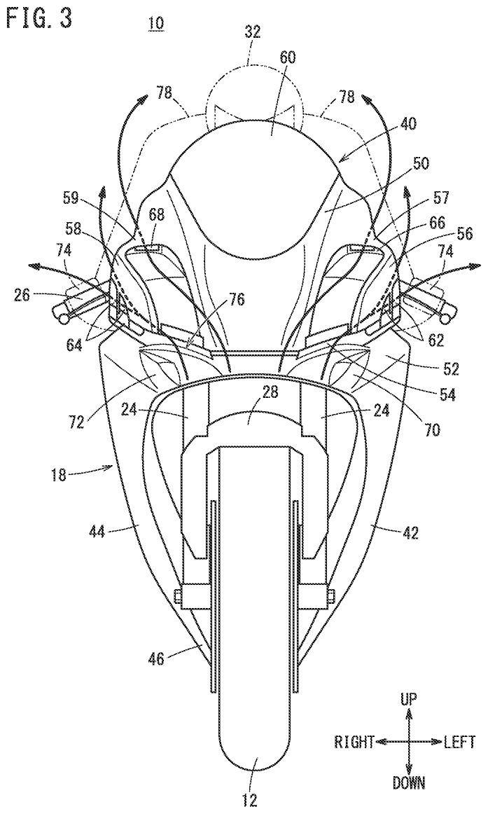

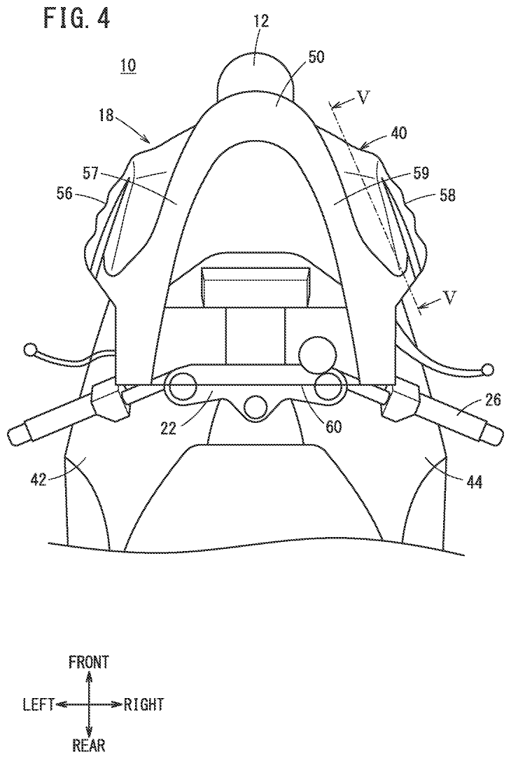

FIG. 1 is a right side view of the motorcycle 10 (saddle-type vehicle). FIG. 2 is a perspective view of the motorcycle 10 shown in FIG. 1. FIG. 3 is a front view of the motorcycle 10 shown in FIG. 1. FIG. 4 is a plan view of a front portion of the motorcycle 10 shown in FIG. 1. In the following explanation, front and rear directions, left and right directions, and up and down directions will be described with respect to a direction in which the motorcycle 10 moves forward is defined as the front direction.

As shown in FIG. 1, the motorcycle 10 includes a front wheel 12, a rear wheel 14, a body frame 16 (body), and a cowl 18.

The body frame 16 includes a head pipe 20. The head pipe 20 is a part of a front end portion of the body frame 16. A steering shaft (not shown) is rotatably supported by the head pipe 20. A top bridge 22 (see FIG. 4) is fixed to an upper end of the steering shaft. The top bridge 22 connects upper portions of a pair of left and right front forks 24 (see FIG. 3). A bottom bridge (not shown) is fixed to a lower end of the steering shaft. The bottom bridge connects the pair of left and right front forks 24. The front wheel 12 is rotatably supported at lower end portions of the pair of left and right front forks 24. The front wheel 12 is steerably supported at a front end portion of the body frame 16 via the pair of left and right front forks 24. A handle 26 is fixed to an upper portion of the top bridge 22. A front fender 28 is attached to the pair of left and right front forks 24. The front fender 28 covers the front wheel 12 from above.

As shown in FIG. 1, the rear wheel 14 is supported at a rear portion of the body frame 16. A seat 30 is supported on an upper portion of the body frame 16. An occupant 32 of the motorcycle 10 is seated on the seat 30. Steps 34 are provided at a lower portion of the body frame 16. The occupant 32 seated on the seat 30 may place their feet 36 on the steps 34.

The cowl 18 includes a front cowl 40 (front cowl structure), a pair of left and right middle cowls 42 and 44, and a lower cowl 46.

The front cowl 40 covers a front portion of the body frame 16 from the front side. The front portion of the body frame 16 includes the head pipe 20 and suchlike.

The pair of left and right middle cowls 42 and 44 are connected to both ends of the front cowl 40 in the left-right direction (vehicle widthwise direction). As shown in FIG. 3, the pair of left and right middle cowls 42 and 44 cover the front portion of the body frame 16 from both left and right sides.

Specifically, the left middle cowl 42 is connected to the left end portion of the front cowl 40. The left middle cowl 42 extends obliquely down-rearward from the left end portion of the front cowl 40. The left middle cowl 42 covers the front portion of the body frame 16 from the left direction.

As shown in FIG. 1, the right middle cowl 44 is connected to the right end portion of the front cowl 40. The right middle cowl 44 extends obliquely down-rearward from the right end portion of the front cowl 40. The right middle cowl 44 covers the front portion of the body frame 16 from the right direction.

The lower cowl 46 is connected to lower ends of the pair of left and right middle cowls 42 and 44. As shown in FIG. 2, the lower cowl 46 covers the lower portion of the body frame 16 from below.

The front cowl 40 includes a first front cowl portion a second front cowl portion 52, concave portions 54, and a pair of left and right side panel portions 56 and 58.

The first front cowl portion 50 covers the front portion of the body frame 16 from the front side. Specifically, the first front cowl portion 50 covers the head pipe 20, a central portion of the handle 26, the steering shaft, the top bridge 22, and suchlike from the front side. As shown in FIG. 4, the first front cowl portion 50 expands in the left-right direction (outward in the vehicle widthwise direction) as the first front cowl portion 50 extends rearward. As shown in FIG. 1, the first front cowl portion 50 is inclined up-rearward. As shown in FIG. 2, a windscreen 60 is provided at a central portion of the first front cowl portion 50 in the left-right direction.

Below the first front cowl portion 50, the second front cowl portion 52 covers the front portion of the body frame 16 from the front side. Specifically, the second front cowl portion 52 covers upper portions of the pair of left and right front forks 24 and suchlike from the front side. The second front cowl portion 52 expands in the left-right direction as the second front cowl portion 52 extends rearward. The second front cowl portion 52 is inclined up-rearward. As shown in FIG. 3, the left middle cowl 42 is connected to a left end portion of the second front cowl portion 52. The right middle cowl 44 is connected to a right end portion of the second front cowl portion 52.

As shown in FIG. 1, the concave portion 54 extends in the front-rear direction so as to connect the lower portion of the first front cowl portion 50 and the upper portion of the second front cowl portion 52. As shown in FIG. 3, the concave portion 54 is sunken inward in the vehicle widthwise direction with respect to the first front cowl portion 50 and the second front cowl portion 52.

As described above, the first front cowl portion 50 and the second front cowl portion 52 expand in the left-right direction and incline upward as they extends rearward. Therefore, as shown in FIG. 2, the concave portion 54 expands in the left-right direction as the concave portion 54 extends rearward. As shown in FIG. 1, the concave portion 54 inclines up-rearward.

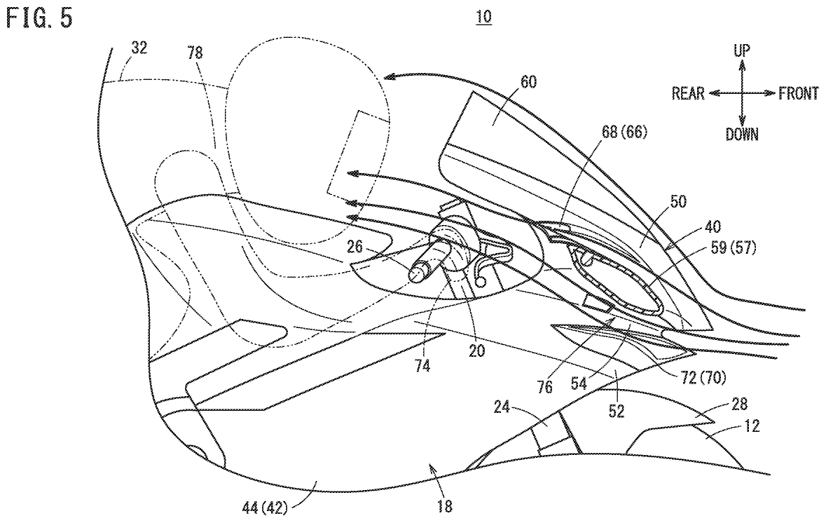

FIG. 5 is a sectional view taken along the line V-V in FIG. 4. FIG. 5 shows a state in which the side panel portions 56 and 58 (see FIG. 4) have been removed from the first front cowl portion 50. As shown in FIG. 5, a left end portion 57 and a right end portion 59 of the first front cowl portion 50 have an inverted wing shape in a side view. That is, the left end portion 57 and the right end portion 59 of the first front cowl portion 50 have, in a side view, a shape obtained by turning an airfoil of a flying object upside down. Accordingly, lower portions of the left end portion 57 and the right end portion 59 of the first front cowl portion 50 curves so as to be convex downward.

As shown in FIG. 1, the left end portion 57 and the right end portion 59 of the first front cowl portion 50 are provided with side panel portions 56 and 58, respectively.

As shown in FIG. 3, the left side panel portion 56 extends downward from the left end portion 57 of the first front cowl portion 50. The left side panel portion 56 covers the left end portion 57 of the first front cowl portion 50 so as to cover a part of a left side portion of the concave portion 54. As shown in FIG. 4, the left side panel portion 56 expands to the left as the left side panel portion 56 extends rearward. The left side panel portion 56 inclines up-rearward.

As shown in FIG. 2, the right side panel portion 58 extends downward from the right end portion 59 of the first front cowl portion 50. The right side panel portion 58 covers the right end portion 59 of the first front cowl portion 50 so as to cover a part of a right side portion of the concave portion 54. As shown in FIG. 4, the right side panel portion 58 expands to the right as the right side panel portion 58 extends rearward. As shown in FIG. 1, the right side panel portion 58 inclines up-rearward.

The pair of left and right side panel portions 56 and 58 are formed with first slit portions 62 and 64. The left side panel portion 56 is formed with two of the first slit portions 62. The two first slit portions 62 of the left side panel portion 56 communicate with a rear portion of the left side portion of the concave portion 54. The right side panel portion 58 is formed with two of the first slit portions 64. The two first slit portions 64 of the right side panel portion 58 communicate with a rear portion of the right side portion of the concave portion 54.

As shown in FIG. 3, second slit portions 66 and 68 are formed on the left and right sides of the first front cowl portion 50, respectively. Each of the left and right second slit portions 66 and 68 is formed in the front-rear direction at the first front cowl portion 50. The left second slit portion 66 is formed above the left side panel portion 56 at the first front cowl portion 50. The right second slit portion 68 is formed above the right side panel portion 58 at the first front cowl portion 50.

Projections 70 and 72 are provided on both left and right sides of the front portion of the second front cowl portion 52. Each of the pair of left and right projections 70 and 72 extends upward from both left and right sides of the front portion of the second front cowl portion 52. The left projection 70 extends obliquely upward as the left projection 70 extends rearward from the left front portion of the second front cowl portion 52. The left projection 70 expands to the left and inclines upward as the left projection 70 extends rearward. The right projection 72 extends obliquely upward as the right projection 72 extends rearward from the right front portion of the second front cowl portion 52. The right projection 72 expands to the right and inclines upward as the right projection 72 extends rearward.

The operation and effect of the front cowl 40 coupled to the motorcycle 10 of the first embodiment constructed as described above will be described. Here, a description will be given of a case where the occupant 32 seated on the seat 30 moves the motorcycle 10 forward with their feet 36 placed on the steps 34.

As shown in FIG. 1, the occupant 32 seated on the seat 30 grips both ends of the handle 26 with the left and right hands 74 and drives the motorcycle 10, bending forward. As shown by arrows in FIG. 1, when the motorcycle 10 travels forward, a running air flows from the front side toward the motorcycle 10.

Part of the running air having reached the first front cowl portion 50 and the second front cowl portion 52 flows into the concave portions 54. The running air flowing into the concave portions 54 flows through the space 76 formed by the concave portions 54, the side panel portions 56, 58 and the projections 70, 72. The left end portion 57 and the right end portion 59 of the first front cowl portion 50 have an inverted wing shape in a side view. Thus, when the running air flows through the space 76, a down force is produced with respect to the first front cowl portion 50. The down force acts as a force to press the front portion of the motorcycle 10 downward (toward road surface). The running air flowing through the space 76 is discharged rearward.

The space 76 is formed by the concave portions 54, the side panel portions 56, 58 and the projections 70, 72. In this way, it is possible to prevent widthwise outward diffusion of the running air flowing into the space 76. As a result, the down force can be increased.

Part of the running air flowing through the space 76 is discharged from the second slit portions 66 and 68 to the outside in the vehicle widthwise direction. As a result, it can be prevented that the drag to the turning directions of the motorcycle 10 becomes too large and the body motion of the motorcycle 10 is restrained.

Part of the running air that has reached the first front cowl portion 50 flows along the surface of the first front cowl portion 50. The running air flowing along the surface of the first front cowl portion 50 is discharged rearward through the first slit portions 62 and 64. Further, another part of the running air that has reached the first front cowl portion 50 flows rearward along the first front cowl portion 50 and the windscreen 60. As a result, it can be prevented that the drag to the turning directions of the motorcycle 10 becomes too large and the body motion of the motorcycle 10 is restrained.

The running air discharged rearward flows above left and right shoulders 78 of the occupant 32 and on further outer sides than the occupant 32 in the vehicle widthwise direction. Thus, it is possible to prevent the running air from directly hitting the occupant 32. That is, the running air flows so as to surround the occupant 32. Therefore, the running air discharged rearward functions as an air curtain that surrounds the occupant 32. As a result, the aerodynamic drag acting on the occupant 32 can be reduced.

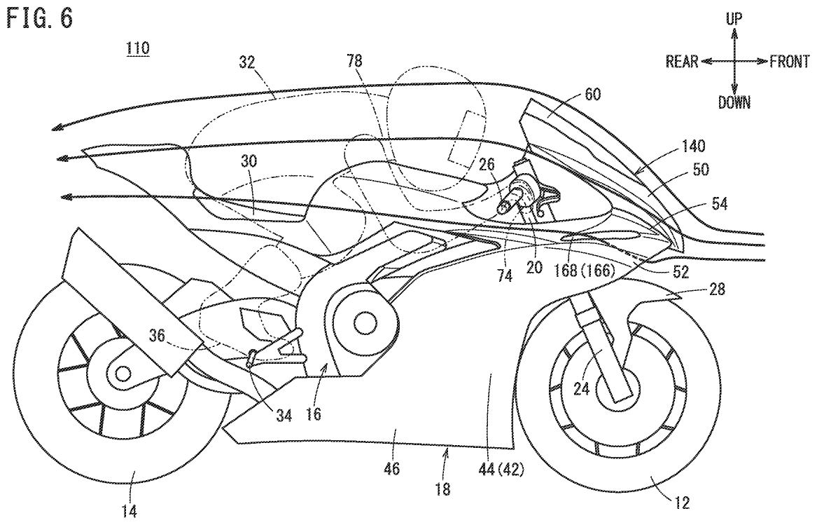

A motorcycle 110 (saddle-type vehicle) according to a second embodiment will be described with reference to FIGS. 6 to 10.

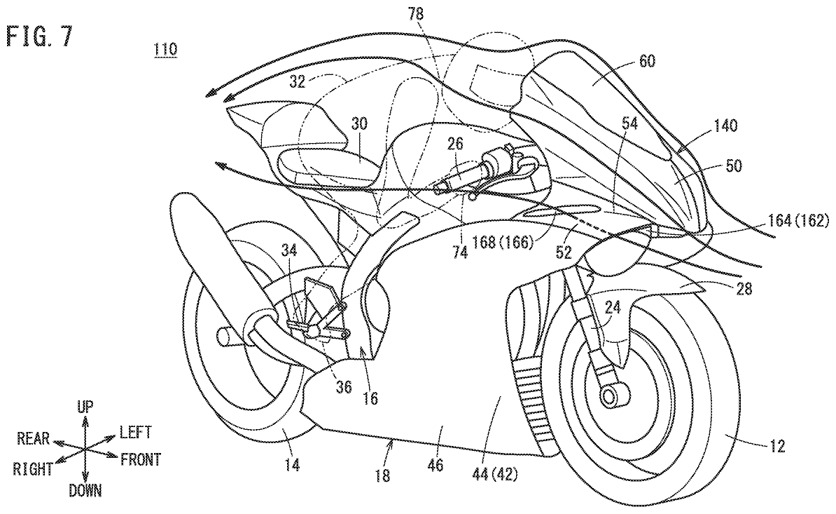

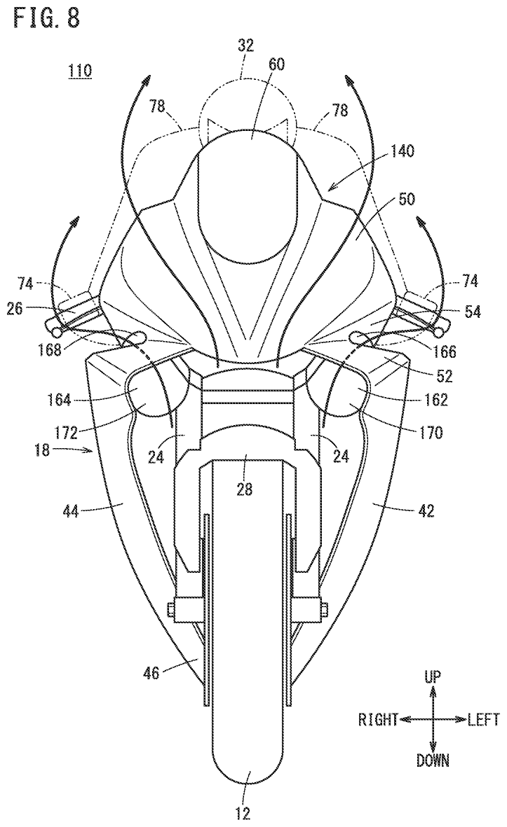

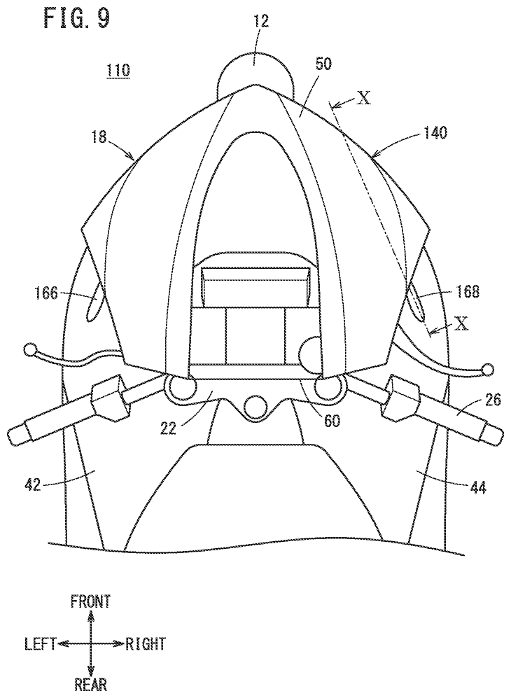

FIG. 6 is a right side view of the motorcycle 110. FIG. 7 is a perspective view of the motorcycle 110 shown in FIG. 6. FIG. 8 is a front view of the motorcycle 110 shown in FIG. 6. FIG. 9 is a plan view of a front portion of the motorcycle 110 shown in FIG. 6. With respect to the motorcycle 110, the same components as those of the motorcycle 10 according to the first embodiment (see FIGS. 1 to 5) are denoted by the same reference numerals, and detailed description thereof is omitted.

The cowl 18 includes a front cowl 140 (front cowl structure), a pair of left and right middle cowls 42 and 44, and a lower cowl 46. The front cowl 140 has a first front cowl section 50, a second front cowl section 52, and concave portions 54. As shown in FIG. 7, a windscreen 60 is provided at a central portion of the first front cowl portion 50.

As shown in FIG. 8, introduction ports 162 and 164 are formed at the front portion of the second front cowl portion 52. Specifically, the introduction ports 162 and 164 are formed on the left and right sides of the front portion of the second front cowl portion 52, respectively. Each of the left and right introduction ports 162 and 164 opens forward. Each of the left and right introduction ports 162 and 164 has a circular shape. The left and right introduction ports 162 and 164 are openings having the same size.

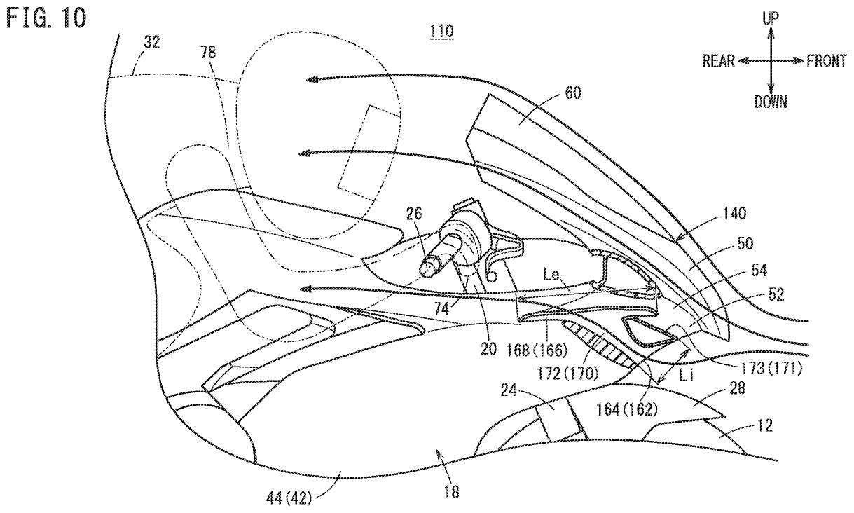

As shown in FIG. 6, discharge ports 166 and 168 are formed at the rear upper portion of the second front cowl portion 52. Specifically, as shown in FIG. 9, the discharge ports 166 and 168 are formed on the left and right sides of the rear upper portion of the second front cowl portion 52, respectively. As shown in FIG. 10, each of the left and right discharge ports 166 and 168 opens toward the concave portions 54. Accordingly, the left and right discharge ports 166 and 168 are positioned above the left and right introduction ports 162 and 164. That is, the left and right introduction ports 162 and 164 are positioned below the left and right discharge ports 166 and 168. Each of the left and right discharge ports 166 and 168 has an oval shape. The left and right discharge ports 166 and 168 are openings having the same size.

The diameter Li of the smallest circle including the left introduction port 162 is smaller than the diameter Le of the smallest circle including the left discharge port 166 (Li<Le). The cross-sectional area Si of the left introduction port 162 is larger than the cross-sectional area Se of the left discharge port 166 (Si>Se). The diameter Li of the smallest circle including the right introduction port 164 is smaller than the diameter Le of the smallest circle including the right discharge port 168 (Li<Le). The cross-sectional area Si of the right introduction port 164 is larger than the cross-sectional area Se of the right discharge port 168 (Si>Se).

FIG. 10 is a sectional view taken along the line X-X in FIG. 9. As shown in FIG. 10, the second front cowl portion 52 is formed with running air paths 170 and 172 that let the introduction ports 162 and 164 and the discharge ports 166 and 168 communicate with each other. Specifically, as shown in FIG. 8, the running air path 170 is formed at a left portion of the second front cowl portion 52 to let the left introduction port 162 and the left discharge port 166 communicate with each other. The running air path 172 is formed at a right portion of the second front cowl portion 52 to let the right side introduction port 164 and the right side discharge port 168 communicate with each other. Each of the left and right running air paths 170 and 172 expands outward in the vehicle widthwise direction as they approaches the discharge ports 166 and 168. Further, as shown in FIG. 10, since the left and right discharge ports 166 and 168 are positioned above the left and right introduction ports 162 and 164, the left and right running air paths 170 and 172 respectively extend upward as they approach the discharge ports 166 and 168.

Of the second front cowl portion 52, upper portions 171 and 173 above the left and right running air paths 170 and 172 have an inverted wing shape in a side view. The upper portions 171 and 173 of the second front cowl portion 52 have, in a side view, a shape obtained by turning an airfoil of a flying object upside down. Accordingly, the upper portions 171 and 173 curves so as to be convex downward.

The operation and effect of the front cowl 140 coupled to the motorcycle 110 of the second embodiment constructed as described above will be described. Here, a description will be given of a case where the occupant 32 seated on the seat 30 moves the motorcycle 110 forward with their feet 36 placed on the steps 34.

As shown in FIG. 6, the occupant 32 seated on the seat 30 grips both ends of the handle 26 with the left and right hands 74 and drives the motorcycle 110, bending forward. As shown by arrows in FIG. 6, when the motorcycle 110 travels forward, a running air flows from the front side toward the motorcycle 110.

Part of the running air having reached the first front cowl portion 50 and the second front cowl portion 52 flows into the running air paths 170 and 172 through the left and right introduction ports 162 and 164. The running air having flowed into the right and left running air paths 170 and 172 flows rearward through the running air paths 170 and 172. The upper portions 171 and 173 of the second front cowl portion 52 have an inverted wing shape when viewed from the side. Thus, when the running air flows through the running air paths 170 and 172, a down force is generated on the second front cowl portion 52. The down force acts as a force to press the front portion of the motorcycle 110 downward (toward road surface). The running air flowing through the left and right running air paths 170 and 172 is discharged from the discharge ports 166 and 168 to the rear parts of the concave portions 54.

Another part of the running air that has reached the first front cowl portion 50 and the second front cowl portion 52 flows rearward along the concave portions 54.

Part of the running air that has reached the first front cowl portion 50 flows rearward along the surface of the first front cowl portion 50. Further, another part of the running air that has reached the first front cowl portion 50 flows rearward along the first front cowl portion 50 and the windscreen 60. As a result, it can be prevented that the drag to the turning directions of the motorcycle 110 becomes too large and the body motion of the motorcycle 110 is restrained.

Part of the running air discharged rearward flows above the left and right shoulders 78 of the occupant 32 and on further outer sides than the occupant 32 in the vehicle widthwise direction. Further, another part of the running air discharged rearward flows on further outer sides in the vehicle widthwise direction than the left and right hands 74 of the occupant 32. Thus, it is possible to prevent the running air from directly hitting the occupant 32.

The invention that can be understood from the above embodiments will be described below.

A first aspect of the present invention is a front cowl structure (40) for a saddle-type vehicle (10). The front cowl structure (40) includes a first front cowl portion (50) that covers a vehicle body (16) from a front side, a second front cowl portion (52) that covers the vehicle body (16) from the front side below the first front cowl portion (50), and a concave portion (54) that extends in the front-rear direction of the saddle-type vehicle (10), connects the first front cowl portion (50) and the second front cowl portion (52) with each other, and is sunken inward in the vehicle widthwise direction. The concave portion (54) expands outward in the vehicle widthwise direction and inclines upward as the concave portion extends rearward the rear, and both end portions (57, 59) of the first front cowl portion (50) have an inverted wing shape in a side view of the saddle-type vehicle (10).

In the present invention, the downforce can be increased by the first front cowl portion having an inverted wing shape. In addition, because wings are unnecessary, aerodynamic drag can be reduced. Thus, the motion performance (maximum speed and acceleration performance) of the saddle-type vehicle improves and as a result, the fuel consumption performance can improve. Further, the running air flowing along the concave portion flows upward and outward as the running air goes rearward. Thus, it is possible to mitigate the direct impact of the running air on the occupant of the saddle-type vehicle and further reduce the aerodynamic drag. Further, if the present invention is applied to a saddle-type vehicle of a supersport type, it becomes possible to realize a sharp design with a reduced vehicle width. Thus, the design of the saddle-type vehicle can be improved.

In the first aspect of the present invention, on outer sides of the end portions (57, 59) of the first front cowl portion (50) in the vehicle widthwise direction, side panel portions (56, 58) covering the end portions (57, 59) may be provided, and the side panel portions (56, 58) may extend downward covering part of the concave portion (54) from the outer side in the vehicle widthwise direction, and expand outward in the vehicle widthwise direction and incline upward as the side panel portions extend rearward.

As a result, it is possible to suppress widthwise outward diffusion of the running air having flowed into the concave portions. As a result, the down force can be further increased.

In the first aspect of the present invention, the side panel portions (56, 58) may be formed with first slit portions (62, 64) that discharge, to the outer side in the vehicle widthwise direction, running air flowing from the front side into the concave portion (54).

As a result, the running air having flowed into the concave portions can be appropriately released outward in the vehicle widthwise direction. As a result, it can be prevented that the vehicle body motion of the saddle-type vehicle is restrained because of the running air. Further, it is possible to mitigate the direct impact of the running air on the occupant of the saddle-type vehicle. As a result, the aerodynamic drag can be further reduced.

In the first aspect of the present invention, a projection (70, 72) extending upward may be provided on the outer side of the second front cowl portion (52) in the vehicle widthwise direction, and the projection (70, 72) may extend outward in the vehicle widthwise direction and incline upward as the projection extends rearward.

As a result, the running air can be efficiently made to flow into the concave portions. Further, it is possible to suppress widthwise outward diffusion of the running air having flowed into the concave portions. As a result, the down force can be further increased. Further, because the projections expand to the outside in the vehicle widthwise direction, the running air that has not flowed into the concave portions can be released to the outside in the vehicle widthwise direction. As a result, it is possible to prevent the running air that has not flowed into the concave portions from directly hitting the occupant of the saddle-type vehicle.

In the first aspect of the present invention, the first front cowl portion (50) may be formed with second slit portions (66, 68) that discharge rearward the running air flowing along the first front cowl portion (50).

As a result, it is possible to prevent the body motion of the saddle-type vehicle from being restrained because of the running air. Further, the running air discharged rearward from the second slit portion flows along the occupant of the saddle-type vehicle. As a result, the running air discharged rearward functions as an air curtain that envelops the occupant, and it is possible to reduce the range of wind protection for the occupant. As a result, the aerodynamic drag can be further reduced.

A second aspect of the present invention is a front cowl structure (140) of a saddle-type vehicle (110). The front cowl structure (140) includes a first front cowl portion (50) that covers a vehicle body (16) from the front side, and a second front cowl portion (52) that covers the vehicle body (16) from the front side below the first front cowl portion (50). A front portion of the second front cowl portion (52) is formed with an introduction port (162, 164), a rear upper portion of the second front cowl portion (52) is formed with a discharge port (166, 168), the second front cowl portion (52) is formed with a running path (170, 172) that connects the introduction port (162, 164) and the discharge port (166, 168) with each other, and the running air introduced from the introduction port (162, 164) is discharged rearward from the discharge port (166, 168) through the running air path, the running air path (170, 172) expands outward in the vehicle widthwise direction of the saddle-type vehicle (110) and extends upward as the running air path approaches the discharge port (166, 168), and a portion (171, 173) of the second front cowl portion (52) above the running air path (170, 172) has an inverted wing shape in a side view of the saddle-type vehicle (110).

The present invention increases the down force by forming the portion of the second front cowl portion above the running air path into an inverted wing shape. In addition, because wings are unnecessary, aerodynamic drag can be reduced. Thus, the motion performance (maximum speed and acceleration performance) of the saddle-type vehicle can be improved, and as a result, the fuel consumption performance can be improved. Further, the running air flows from the introduction port through the running air path and is discharged backward from the discharge port. Accordingly, it is possible to prevent the stagnation of the running air near a front tire housing space. Further, the running air discharged backward from the discharge port flows along the occupant of the saddle-type vehicle. Thus, the discharged running air functions as an air curtain (wind protection) wraps the occupant. As a result, the wind protection range for the occupant can be reduced, and the size (projected area) of the saddle-type vehicle when viewed from the front can be reduced. Therefore, aerodynamic drag can be further reduced. Further, if the present invention is applied to a saddle-type vehicle of a supersport type, it becomes possible to realize a sharp design with a reduced vehicle width. Thus, the design of the saddle-type vehicle can be improved.

In the second aspect of the present invention, the introduction port (162, 164) and the discharge port (166, 168) may be formed in a manner so that the diameter (Li) of the smallest circle including the introduction port (164, 162) is smaller than the diameter (Le) of the smallest circle including the discharge port (166, 168), and the cross-sectional area (Si) of the introduction port (162, 164) is larger than the cross-sectional area (Se) of the discharge port (166, 168).

Thus, the running air can be efficiently introduced from the introduction port. Further, in the inside of the running air path, the flow velocity of the running air can be increased as the running air path approaches the discharge port. The running air discharged from the discharge port flows further outside in the vehicle widthwise direction than the occupant of the saddle-type vehicle. As a result, the running air discharged from the discharge port functions as a wind protection for the occupant. Accordingly, the function of the wind protection for the occupant is improved, and the size (projected area) of the saddle-type vehicle when viewed from the front can be reduced. Therefore, the aerodynamic drag can be further reduced.

In the second aspect of the present invention, the introduction ports (162, 164) may have a circular shape, and the discharge ports (166, 168) may have an elliptical shape.

Thus, the function of the wind protection for the occupant can be further improved.

In the second aspect of the present invention, the front cowl structure (140) may further include a concave portion (54) that extends in the front-rear direction of the vehicle body (16), connects the first front cowl portion (50) and the second front cowl portion (52) with each other, and is sunken inward in the vehicle widthwise direction with respect to the first front cowl portion (50) and the second front cowl portion (52). The concave portion (54) may expand outward in the vehicle widthwise direction and incline inward as the concave portion extends rearward.

Thus, the running air flowing along the concave portions flows upward and outward as it goes rearward. Thus, it is possible to mitigate the direct impact of the running air on the occupant of the saddle-type vehicle and further reduce the aerodynamic drag.

In the second aspect of the present invention, the introduction port (162, 164) may be positioned below the discharge port (166, 168) at the front portion of the second front cowl portion (52), and the discharge port (166, 168) may be open toward the concave portion (54) at the rear portion of the second front cowl portion (52).

Thus, the running air can be discharged rearward, being raised from the discharge port. As a result, the down force can be further increased.

It should be noted that the present invention is not limited to the above-described disclosure and various configurations can be adopted without departing from the gist of the present invention.

What is claimed is:

1. A front cowl structure of a saddle-type vehicle comprising:
a first front cowl portion that covers a vehicle body from a front side;
a second front cowl portion that covers the vehicle body from the front side below the first front cowl portion; and
a concave portion that extends in a front-rear direction of the saddle-type vehicle, connects the first front cowl portion and the second front cowl portion with each other, and is sunken inward in a vehicle widthwise direction,
wherein
the concave portion extends outward in the vehicle widthwise direction and inclines upward as the concave portion extends rearward, and
both end portions of the first front cowl portion have an inverted wing shape in a side view of the saddle-type vehicle.

2. The front cowl structure according to claim 1, wherein
on outer sides of the end portions of the first front cowl portion in the vehicle widthwise direction, side panel portions covering the end portions are provided, and
the side panel portions extend downward covering part of the concave portion from an outer side in the vehicle widthwise direction, and expand outward in the vehicle widthwise direction and incline upward as the side panel portions extend rearward.

3. The front cowl structure according to claim 2, wherein
the side panel portions are formed with first slit portions that discharge, to the outer side in the vehicle widthwise direction, running air flowing from the front side into the concave portion.

4. The front cowl structure according to claim 1, wherein
a projection extending upward is provided on an outer side of the second front cowl portion in the vehicle widthwise direction, and
the projection extends outward in the vehicle widthwise direction and incline upward as the projection extends rearward.

5. The front cowl structure according to claim 1, wherein
the first front cowl portion is formed with second slit portions that discharge rearward the running air flowing along the first front cowl portion.

6. A front cowl structure of a saddle-type vehicle comprises:
a first front cowl portion that covers a vehicle body from a front side;
a second front cowl portion that covers the vehicle body from the front side below the first front cowl portion; and
wherein
a front portion of the second front cowl portion is formed with an introduction port,
a rear upper portion of the second front cowl portion is formed with a discharge port,
the second front cowl portion is formed with a running air path that connects the introduction port and the discharge port with each other, and the running air introduced from the introduction port is discharged rearward from the discharge port through the running air path,
the running air path expands outward in a vehicle widthwise direction of the saddle-type vehicle and extends upward as the running air path approaches the discharge port, and
a portion of the second front cowl portion above the running air path has an inverted wing shape in a side view of the saddle-type vehicle.

7. The front cowl structure according to claim 6, wherein
the introduction port and the discharge port are formed in a manner so that a diameter of a smallest circle including the introduction port is smaller than a diameter of a smallest circle including the discharge port, and a cross-sectional area of the introduction port is larger than a cross-sectional area of the discharge port.

8. The front cowl structure according to claim 7, wherein
the introduction port has a circular shape, and
the discharge port has an elliptical shape.

9. The front cowl structure according to claim 6, further comprising
a concave portion that extends in a front-rear direction of the vehicle body, connects the first front cowl portion and the second front cowl portion with each other, and is sunken inward in the vehicle widthwise direction with respect to the first front cowl portion and the second front cowl portion,
wherein the concave portion extends outward in the vehicle widthwise direction and inclines upward as the concave portion extends rearward.

10. The front cowl structure according to claim 9, wherein
the introduction port is positioned below the discharge port at a front portion of the second front cowl portion, and
the discharge port is open toward the concave portion at a rear portion of the second front cowl portion.
